(19) United States
(12) Patent Application Publication
(10) Pub. No.: US 2014/0037290 A1
(43) Pub. Date: Feb. 6, 2014

(54) Method and System for Reducing Noise Associated with Optical Signals

(71) Applicant: Youichi Akasaka, Allen, TX (US)

(72) Inventor: Youichi Akasaka, Allen, TX (US)

(73) Assignee: Fujitsu Limited, Kanagawa (JP)

(21) Appl. No.: 13/564,930

(22) Filed: Aug. 2, 2012

(51) Int. Cl. H04B 10/18

(52) U.S. Cl. 398/65

(57) ABSTRACT

In accordance with an embodiment of the present disclosure a network element comprises a plurality of optically absorbent layers. Each layer of the plurality of optically absorbent layers is configured to receive an optical signal such that the optical signal passes through the layer. The optical signal has a specific polarization state and is associated with noise having a plurality of randomly varying polarization states. Each layer absorbs optical waves having a particular polarization state. The particular polarization state of each layer is different from the polarization state associated with the other layers of the plurality of optically absorbent layers. The plurality of layers are coupled together such that as the optical signal and associated noise pass through the plurality of layers, the network element absorbs the associated noise more than the polarized optical signal to improve an Optical Signal to Noise Ratio (OSNR) of the optical signal.

### TECHNICAL FIELD

The present disclosure relates generally to optical networks and, more particularly, to a system and method for reducing noise associated with optical signals.

### BACKGROUND

Telecommunications systems, cable television systems and data communication networks use optical networks to rapidly convey large amounts of information between remote points. In an optical network, information (“traffic”) is conveyed in the form of optical signals through optical fibers. The optical signals may comprise a beam of light having a specific wavelength and having the traffic modulated onto the beam. In some instances a wavelength configured to carry information may be referred to as an “optical channel” or a “channel.” Each channel may be configured to carry a certain amount of information through an optical network at a particular data rate.

However, as an optical signal propagates through a network noise associated with the signal may increase, which may decrease the Optical Signal to Noise Ratio (OSNR). If the OSNR is sufficiently low, the information modulated on the optical signal may not be detected by optical receivers associated with the optical network. Accordingly, as an optical signal propagates from one location to another, the signal may undergo multiple optical to electrical to optical (OEO) conversions to remove the optical noise and regenerate the optical signal. Implementing such OEO regenerations may be costly.

Additionally, the techniques used to increase the amount of traffic carried by an optical signal may reduce the distance that an optical signal may travel before requiring an OEO conversion (also known as the “reach” of the optical signal). For example, a high capacity (e.g., a 400 Gigabits/second (400 G)) optical signal may have more stringent performance requirements (e.g., a higher Optical Signal to Noise Ratio (OSNR) requirement) than lower capacity optical signals (e.g., 10 G, 40 G, 100 G optical signals). As such, the reach of high capacity optical signals may be smaller than the reach of lower capacity optical signals.

### SUMMARY

In accordance with the present disclosure, disadvantages and problems associated with transmitting optical signals may be reduced. In accordance with one or more embodiments of the present disclosure a network element comprises a plurality of optically absorbent layers. Each layer is configured to receive an optical signal such that the optical signal passes through the layer. The optical signal has a specific polarization state and is associated with noise having a plurality of randomly varying polarization states. Each layer absorbs optical waves having a particular polarization state. The particular polarization state of each layer is different from the polarization state associated with the other layers. The plurality of layers are coupled together such that as the optical signal and associated noise pass through the plurality of layers, the network element absorbs the associated noise more than the polarized optical signal to improve an Optical Signal to Noise Ratio (OSNR) of the optical signal.

### BRIEF DESCRIPTION OF THE DRAWINGS

Embodiments of the present disclosure are made by way of example and are not limited to the following figures in which:

FIG. 1 illustrates an example embodiment of an optical network, in accordance with some embodiments of the present disclosure;

FIG. 2A illustrates an example of a noise reducer configured to optically reduce noise associated with an optical signal, in accordance with some embodiments of the present disclosure;

FIG. 2B illustrates the polarization states associated with the noise reducer, optical signal and noise of FIG. 2A, in accordance with some embodiments of the present disclosure; and

FIG. 3 illustrates an example of a noise reducer comprising layers that include quantum dots, in accordance with some embodiments of the present disclosure.

### DETAILED DESCRIPTION

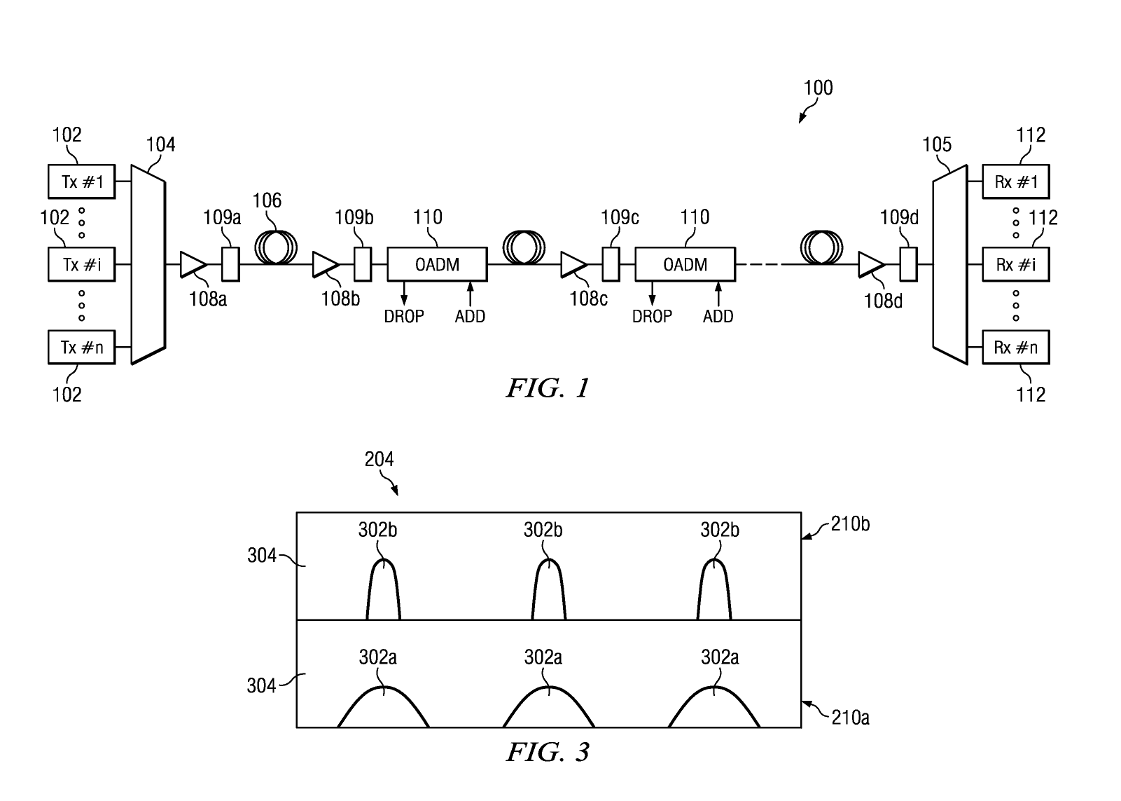

FIG. 1 illustrates an example embodiment of an optical network 100, in accordance with some embodiments of the present disclosure. As discussed in further detail below, a network element of optical network 100 may be configured to remove noise (e.g., Amplified Spontaneous Emission (ASE) noise) from optical signals in the optical domain to maintain an acceptable Optical Signal to Noise Ratio (OSNR) of the optical signal. As described below, such a configuration may increase the reach of the optical signals and reduce the number of optical to electrical to optical (OEO) regenerations, which can be costly to implement.

Optical network 100 may include one or more optical fibers 106 configured to transport one or more optical signals communicated by network elements of optical network 100. A network element may refer to any number of components that an optical signal may pass through while propagating through optical network 100. The network elements of optical network 100 may be coupled together by fibers 106 and may comprise one or more transmitters 102, one or more multiplexers (MUX) 104, one or more amplifiers 108, one or more noise reducers 109, one or more optical add/drop multiplexers (OADMs) 110, and one or more receivers 112.

Optical network 100 may comprise a point-to-point optical network with terminal nodes, a ring optical network, a mesh optical network, or any other suitable optical network or combination of optical networks. Optical fibers 106 comprise thin strands of glass capable of communicating the signals over long distances with very low loss. Optical fibers 106 may comprise any suitable type of fiber, such as a Single-Mode Fiber (SMF), Enhanced Large Effective Area Fiber (ELEAF), or a TrueWave® Reduced Slope (TW-RS) fiber.

Optical network 100 may include devices configured to transmit optical signals over fibers 106. Information may be transmitted and received through network 100 by modulation of one or more wavelengths of light to encode the information on the wavelength. In optical networking, a wavelength of light may also be referred to as a channel. Each channel may be configured to carry a certain amount of information through optical network 100 at a certain data rate.

The data rate of a channel may be related to the modulation technique used for the particular channel. For example, in 10 Gigabits/second (10 G) applications, on-off keying (OOK) may be utilized to convey information using two modulation levels. In a 40 G application, Differential Quadrature Phase-shift Keying (DQPSK) may be used to convey information using four modulation levels to increase the information carrying capabilities of a channel over a two level modulation technique such as OOK. Further, in a 100 G application, Dual-polarization QPSK (DP-QPSK) may be used to convey information using four modulation levels for two polarization states to further increase the information carrying capabilities of a channel. Additionally, to implement a 400 G application, orthogonal frequency-division multiplexing (OFDM), Nyquist wavelength division multiplexing (WDM) or narrowed channel spacing WDM may be applied to a dual-polarization 16 quadrature amplitude modulation (DP-16-QAM) format or a dual-polarization 16 phase-shift keying (DP-16-PSK) format. Therefore, various modulation techniques and formats may be used to increase the spectral efficiency of a channel, which may also increase the information carrying capabilities of network 100.

To further increase the information carrying capabilities of optical network 100, multiple signals transmitted at multiple channels may be combined into a single optical signal. The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in optical networks may be limited to the data rate of solely one channel. With more bandwidth, optical networks are capable of transmitting greater amounts of information. Optical network 100 may be configured to transmit disparate channels using WDM, DWDM, or some other suitable multi-channel multiplexing technique, and to amplify the multi-channel signal.

The transmission band of network 100 may refer to a portion of the optical spectrum that includes a range of wavelengths that network 100 is configured to operate within. For example the transmission band in North America may be referred to as the C-band and may include optical wavelengths between approximately 1525 and 1565 nanometers (nm). Therefore, an optical signal transmitted in the C-band may include wavelengths between approximately 1525 and 1565 nm.

Channel power may be related to the OSNR of network 100. The OSNR may relate to the ratio of signal power with respect to noise that may corrupt the signal. The signal power of each channel may need to be sufficiently high to overcome the noise such that the traffic carried by the signal may be extracted from the signal.

The OSNR may be a function of signal propagation distance. As optical signals propagate, the amount of noise affecting the signal may increase with the distance travelled by the signal and/or the number of network elements that the signal may pass through. For example, as a signal propagates from one network element to another via a fiber 106, the signal power may experience span loss while propagating through the fiber 106. Additionally, an amplifier 108 (described further below) may introduce ASE noise through amplification. Further, as the signal passes through various other network elements, each network element may introduce other noise. Accordingly, as an optical signal propagates through an optical network, the OSNR may decrease, which may require OEO signal regeneration.

Additionally, different modulation formats may be more sensitive to noise, such that the OSNR requirements for the different modulation techniques may vary. Accordingly, the distances optical signals may travel before requiring OEO signal regeneration may vary depending on the modulation format used for a particular signal. The distance that an optical signal may be able to travel without requiring OEO regeneration may be referred to as the optical reach of the signal. As mentioned above, different modulation formats may be used to achieve different data carrying capacities, such that the reach of signals with different capacities may vary. For example, the reach of a 400 G signal may be smaller than that of 10 G or 100 G signals.

As mentioned above, OEO regeneration may be expensive such that it may be advantageous to extend the reach of an optical signal. Accordingly, as discussed in further detail below, noise reducer 109 may be configured to remove noise from an optical signal in the optical domain to improve the OSNR of the optical signal such that the reach of the optical signal may be increased. In some embodiments, such a configuration may be used to improve the reach of high capacity (e.g. 400 G) optical signals such that the reach of the high capacity optical signals may move closer to that of traditionally implemented lower capacity optical signals. However, such a configuration may also improve the reach of lower capacity optical signals.

Optical network 100 may include one or more optical transmitters (Tx) 102 configured to transmit optical signals through optical network 100 in specific wavelengths or channels. Transmitters 102 may comprise any system, apparatus or device configured to convert an electrical signal into an optical signal and transmit the optical signal. For example, transmitters 102 may each comprise a laser and a modulator configured to receive electrical signals and modulate the information contained in the electrical signals onto a beam of light produced by the laser at a particular wavelength and transmit the beam carrying the signal throughout the network.

Multiplexer 104 may be coupled to transmitters 102 and may be any system, apparatus or device configured to combine the signals transmitted by transmitters 102, in individual wavelengths, into a single WDM or DWDM signal.

Amplifiers 108 may amplify the multi-channeled signals within network 100 according to the required power levels of each channel. Amplifiers 108 may be positioned before and/or after certain lengths of fiber 106. Amplifiers 108 may comprise any system, apparatus, or device configured to amplify signals. For example, amplifiers 108 may comprise an optical repeater that amplifies the optical signal. This amplification may be performed without opto-electrical or electro-optical conversion. In some embodiments, amplifiers 108 may comprise an optical fiber doped with a rare-earth element. When a signal passes through the fiber, external energy may be applied to excite the atoms of the doped portion of the optical fiber, which increases the intensity of the optical signal. As an example, amplifiers 108 may comprise an erbium-doped fiber amplifier (EDFA). However, any other suitable amplifier, such as a semiconductor optical amplifier (SOA), may be used.

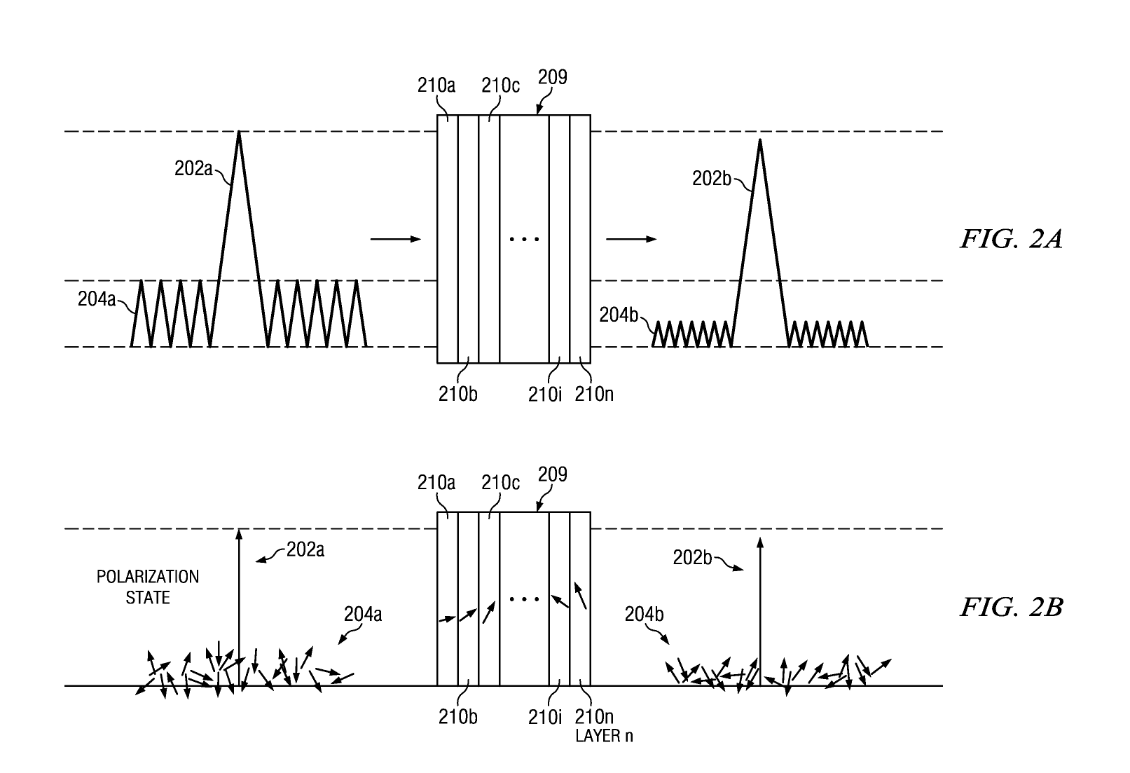

As discussed in detail below with respect to FIGS. 2A and 2B, noise reducers 109 may be configured to optically remove noise from an optical signal such that the reach of the optical signal may be increased. In the present embodiment noise reducers 109 may be placed after each amplifier 108 such that ASE noise introduced in the network by amplifiers 108 may be reduced and/or minimized. Additionally, such a placement of noise reducers 109 with amplifiers 108 may allow for little changes to be made to the infrastructure of optical network 100, which may reduce the cost of implementing noise reducers 109 in optical network 100. However, in other embodiments noise reducers 109 may be placed in any suitable location along optical network 100.

OADMs 110 may be coupled to network 100 via fibers 106 also. OADMs 110 comprise an add/drop modules, which may include any system, apparatus or device configured to add and/or drop optical signals from fibers 106. For example, OADMs may be reconfigurable add/drop multiplexers (ROADMs). After passing through an OADM 110, a signal may travel along fibers 106 directly to a destination, or the signal may be passed through one or more additional OADMs 110 before reaching a destination. Although not expressly shown. In the present disclosure, OADMs 110 may be configured to perform automatic signal regeneration of optical signals received at OADMs 110, as described in further detail below.

Network 100 may also include one or more demultiplexers 105 at one or more destinations of network 100. Demultiplexer 105 may comprise any system apparatus or device that may act as a demultiplexer by splitting a single WDM signal into its individual channels. In some embodiments, demultiplexer 105 may comprise a multiplexer 104 but configured to split WDM signals into their individual channels instead of combine individual channels into one WDM signal. For example, network 100 may transmit and carry a forty channel DWDM signal. Demultiplexer 105 may divide the single, forty channel DWDM signal into forty separate signals according to the forty different channels.

Network 100 may also include optical receivers 112 coupled to demultiplexer 105. Each receiver 112 may be configured to receive signals transmitted in a particular wavelength or channel, and process the signals for the information that they contain.

Modifications, additions or omissions may be made to network 100 without departing from the scope of the disclosure. For example, in some embodiments, each channel in optical network 100 may have the same data rate and in other embodiments one or more channels may have different data rates (e.g., 10 G, 40 G, 100 G, 400 G, etc.). Further, network 100 may include more or fewer elements than those depicted. Additionally network 100 may include additional elements not expressly shown, such as a dispersion control module. Also, as mentioned above, although depicted as a point to point network, network 100 may comprise any suitable network for transmitting optical signals such as a ring or mesh network.

FIG. 2A illustrates an example of a noise reducer 209 configured to optically remove noise 204 associated with an optical signal 202, in accordance with some embodiments of the present disclosure. FIG. 2B illustrates noise reducer 209 and the polarization states associated with optical signal 202 and noise 204 FIG. 2A. Noise reducer 209 may correspond to noise reducers 109 of FIG. 1.

The polarization of an optical signal may refer to the direction of the oscillations of the optical signal. The term “polarization” may generally refer to the path traced out by the tip of the electric field vector at a point in space, which is perpendicular to the propagation direction of the optical signal. The term “linear polarization” may generally refer to a single direction of the orientation of the electric field vector. Generally, an arbitrary linearly polarized wave can be resolved into two independent orthogonal components labeled x and y, which are in phase with each other. The x-polarization component may be aligned with a horizontal axis associated with the wave such that the x-polarization component may be referred to as being “horizontally polarized.” Similarly, the y-polarization component may be aligned with a vertical axis of the wave such that the y-polarization component may be referred to as being “vertically polarized.” The terms “horizontal” polarization and “vertical” polarization are merely used to denote a frame of reference for descriptive purposes, and do not relate to any particular polarization orientation.

Optical signal 202 may have a specific polarization state (e.g., vertical, horizontal, or a combination of both), such that optical signal 202 may be referred to as being “polarized.” In the illustrated embodiment in FIG. 2B, optical signal 202 is depicted as having a vertical polarization state. In the same or alternative embodiments, optical signal 202 may also include a horizontal polarization state. In contrast, the polarization of the optical waves of noise 204 may randomly vary such that noise 204 has a plurality of varying, inconsistent polarization states. Accordingly, noise 204 may be referred to as being “unpolarized.”

As described below, noise reducer 209 may be configured to absorb unpolarized light waves (e.g., noise 204) at a much larger degree than polarized light waves (e.g., optical signal 202). Accordingly, noise reducer 209 may improve the OSNR of optical signal 202, which may improve the optical reach of optical signal 202. As mentioned above, noise reducer 209 may be used with respect to any optical signal, but may be especially advantageous with respect to optical signals with a relatively short reach (e.g., 400 G signals).

Noise reducer 209 may include a plurality of layers 210 of an optically absorbent structure. Each layer 210 may be configured to absorb optical waves having different polarization states. In some embodiments, each layer 210 may be configured to absorb waves having linear polarization states having different orientation angles incrementally changed between 0° (0 radians) and 180° (π radians). In the present example, a horizontal polarization state may correspond with 0° and 180° and a vertical polarization state may correspond with 90° (π/2 radians). For example, layer 210a may be configured to absorb waves with a 0° polarization angle (horizontal polarization), layer 210b may be configured to absorb waves with a 2° polarization angle, layer 210c may be configured to absorb waves with a 4° polarization angle, etc. The above is merely an example, and depending on the number of layers and the application, the amount of change (e.g., difference in degrees or radians) between polarization states associated with layers 210 may be greater or less than that described.

Layers 210 may be made of any suitable optically absorbent structure that may absorb optical waves based on the polarization state of the optical wave. For example, in some embodiments each layer 210 may comprise quantum dots. Quantum dots are nano-sized crystals that may be grown in a semi-conductor type material. The quantum dots may have a polarization sensitivity associated with the shape and size of the quantum dots. Accordingly, quantum dots having a particular shape and size may absorb optical waves having a particular polarization state. Therefore, in accordance with some embodiments of the present disclosure, each layer 210 may include quantum dots having approximately the same size and shape such that the particular layer 210 absorbs optical waves having a polarization state associated with the shape of the quantum dots included in the layer 210.

The layers 210 comprising quantum dots may be manufactured using any suitable process. For example, in some embodiments a layer 210 may comprise a Gallium arsenide (GaAs) substrate having Indium arsenide (InAs) quantum dots embedded therein. In such embodiments, each layer 210 may be manufactured using a molecular beam epitaxy (MBE) process. During the MBE process, Indium (In) and Arsenic (Ar) may be separately injected onto a Gallium arsenide substrate. The Indium and Arsenic may mix to create an Indium arsenide layer on the Gallium arsenide substrate. The Indium arsenide and Gallium arsenide may have lattice constant mismatches that may create tensions on the surface of the Gallium arsenide substrate, which may cause the Indium arsenide to bead on the surface of the Gallium arsenide. The Indium arsenide beads may thus be quantum dots of Indium arsenide. A subsequent layer 210 may be generated by depositing another layer of Gallium arsenide over and around the Indium arsenide quantum dots and depositing more Indium and Arsenic over that layer of Gallium arsenide to create more Indium arsenide quantum dots. This process may be repeated for the desired number of layers 210.

The manner (e.g., rate, amount, etc.) in which the Indium and Arsenic are deposited on the Gallium arsenide substrate may dictate the shape and size of the quantum dots included in each layer. As mentioned above, the shapes and sizes of the quantum dots may relate to the polarization sensitivity of the quantum dots. Therefore, the manner of depositing the Indium and Arsenic on the Gallium arsenide substrate may be adjusted for each layer 210 such that the layer 210 absorbs optical waves having a particular polarization state desired for that layer 210.

FIG. 3 illustrates an example of a noise reducer 209 comprising layers 210 that include quantum dots 302, in accordance with some embodiments of the present disclosure. Each layer 210 may include a substrate 304 (e.g., Gallium arsenide) having quantum dots 302 (e.g., Indium arsenide quantum dots) embedded therein. The quantum dots 302 may be formed using an MBE process as described above. The MBE process may be performed for each layer 210 such that the quantum dots 302 included in each respective layer 210 may have approximately the same size and shape. Therefore, the quantum dots 302 in each respective layer 210 may have approximately the same polarization sensitivity such that each layer 210 may be configured to absorb optical waves having a polarization state associated with the polarization sensitivity of the quantum dots 302 of that layer 210.

For example, layer 210a may include quantum dots 302a having approximately the same size and shape as configured by a controlled MBE process. Similarly, layer 210b may include quantum dots 302b having approximately the same size and shape (but a different size and shape from quantum dots 302a) as configured during an MBE process. Accordingly, layer 210a may be configured to absorb optical waves having one polarization state and layer 210b may be configured to absorb optical waves having another polarization state based on the different shapes and sizes of quantum dots 302a and 302b, respectively, generated during an MBE process.

Modifications, additions, or omissions may be made to FIG. 3 without departing from the scope of the present disclosure. For example, the materials used for the substrate and quantum dots may vary according to particular applications. Additionally, the number and density of quantum dots 302 included in each layer 210 may vary. Further, the shapes and sizes of quantum dots 302 depicted in FIG. 3 are merely for an illustration of comparisons between quantum dots 302 included in each layer 210 and are not actual depictions in size, shape, or scale to actual quantum dots 302 included in a layer 210. Additionally, the number of layers 210 may vary depending on the desired characteristics of noise reducer 209.

Returning to FIG. 2, in other embodiments instead of including quantum dots, each layer 210 may include plasmonic nanoclusters designed for near-field polarization analysis as described in the paper titled: “A Plasmonic Nanocluster Designed for Near-Field Polarization Analysis” by Po-Nan Li, Hsiu-Hao Tsao, and Chen-Bin Huang. (Print ISBN 978-1-4244-8938-1; IEEE; 2011). In embodiments where layers 210 include plasmonic nanoclusters, layers 210 may be manufactured using a sequential process of image reversal photolithography as described in the aforementioned paper. In such embodiments, the geometric design of plasmonic nanoclusters may be configured to be sensitive to the polarization of optical waves such that waves having a certain polarization may be absorbed by the particularly designed surface. Therefore, each nanocluster included in a particular layer 210 may have the same polarization sensitivity such that the particular layer 210 absorbs optical waves having that particular polarization state.

As noise 204 passes through each layer 210, each element of noise 204 with a polarization state associated with a specific layer 210 may be absorbed by that respective layer. Accordingly, each layer 210 may absorb at least a portion of noise 204 such that noise 204 may be substantially reduced after passing through all the layers 210 of noise reducer 209. In contrast, optical signal 202 may be absorbed mainly as it passes through a layer 210 associated with a polarization state substantially similar to the polarization state of optical signal 202, but may not be significantly absorbed by the layers 210 associated with polarization states substantially different from that of optical signal 202. Therefore, noise reducer 209 may absorb optical signal 202 substantially less than noise 204, such that the OSNR of optical signal 202 may be increased by noise reducer 209.

As an example, the illustrated embodiment of FIG. 2A shows optical signal 202a and noise 204a before entering noise reducer 209 and optical signal 202b and noise 204b after leaving noise reducer 209. A comparison shows that the power of optical signal 202b as compared to the power of optical signal 202a may be slightly reduced after passing through noise reducer 209. However, the power of noise 204b as compared to noise 204a may be significantly reduced such that the overall OSNR of optical signal 202b as compared to optical signal 202a may be improved.

The amount of absorption of noise 204 as compared to optical signal 202 may depend on the number of layers 210 included in noise reducer 209. For example, as the number of layers 210 increases, noise reducer 209 may absorb noise 204 substantially more than optical signal 202. Therefore, as the number of layers increases, the OSNR may experience greater improvement. However, too many layers may cause too much loss in the actual signal power, therefore a balance may be determined. This balance may be based on the amount of signal loss created by noise reducer 209. The number of layers 210 absorbing different polarizations may vary depending on the system requirements and characteristics (e.g., span length, etc.) and the desired degree of granularity (e.g., polarization angle difference) between layers. In some embodiments the number of layers may be between fifty (50) and one thousand (1,000).

Although optical signal 202 may pass through a layer 210 configured to absorb optical waves having a different polarization than optical signal 202, in some instances, such a layer 210 may still absorb a portion of optical signal 202. For example, as mentioned above, a layer 210c of layers 210 may be configured to absorb waves with a polarization angle of 4°. Therefore, due to vertical polarization being a component of the polarization being absorbed by layer 210c, a polarized optical wave with vertical polarization (e.g., optical signal 202) may be partially absorbed as it passes through layer 210c of layers 210. Accordingly, each layer 210 may be substantially thin such that absorption of optical signal 202 by each layer 210 may be reduced and/or minimized. For example, in some embodiments each layer 210 may be less than one hundred nanometers (100 nm) thick.

Therefore, noise reducer 209 may be configured to absorb unpolarized optical waves (e.g., noise 204) substantially more than polarized optical waves (e.g., optical signal 202) by comprising a plurality of layers each configured to absorb optical waves having a particular polarization state. Accordingly, noise reducer 209 may optically reduce the noise associated with optical signal 202 and improve the OSNR of optical signal 202, which may in turn improve the reach of optical signal 202. As mentioned earlier, such an embodiment may be used for any suitable optical signal and may be especially useful with respect to optical signals having a relatively short reach.

Modifications, additions or omissions may be made to noise reducer 209 without departing from the scope of the present disclosure. For example, noise reducer 209 may include any number of layers 210 depending on the specific network applications and parameters. Additionally, the thickness of layers 210 may vary depending on the specific network applications and parameters. Further, although layers 210 are described with respect to quantum dots and plasmonic nanoclusters acting as polarization dependent absorbing structures, any suitable polarization dependent absorbing structure may be used.

Although the present disclosure and its advantages have been described in detail, it should be understood that various changes, substitutions and alterations can be made herein without departing from the spirit and scope of the disclosure as defined by the following claims.

What is claimed is:

1. A network element comprising a plurality of optically absorbent layers, each layer of the plurality of optically absorbent layers configured to:
receive an optical signal such that the optical signal passes through the layer, the optical signal having a specific polarization state and is associated with noise having a plurality of randomly varying polarization states; and
absorb optical waves having a particular polarization state, the particular polarization state being different from the polarization state associated with the other layers of the plurality of optically absorbent layers;
wherein the plurality of optically absorbent layers are coupled together such that as the optical signal and associated noise pass through the plurality of optically absorbent layers, the network element absorbs the associated noise more than the polarized optical signal to improve an Optical Signal to Noise Ratio (OSNR) of the optical signal.

2. The network element of claim 1, wherein the plurality of optically absorbent layers comprises between fifty and one thousand layers.

3. The network element of claim 1, wherein each layer of the plurality of optically absorbent layers comprises a plurality of quantum dots configured to absorb optical waves having the particular polarization state associated with the respective layer.

4. The network element of claim 1, wherein each layer of the plurality of optically absorbent layers comprises a plasmonic nanocluster configured to absorb optical waves having the particular polarization state associated with the respective layer.

5. The network element of claim 1, wherein each layer of the plurality of optically absorbent layers has a width less than one hundred nanometers.

6. The network element of claim 1, wherein the network element is configured to receive the optical signal from an optical amplifier to reduce Amplified Spontaneous Emission (ASE) noise associated with the optical amplifier.

7. The network element of claim 1, wherein the optical signal is a 100 Gigabits/second (100 G) or greater optical signal.

8. An optical network comprising:
a plurality of transmitters configured to generate an optical signal having a specific polarization state; and
a noise reducer comprising a plurality of optically absorbent layers, each of the plurality of optically absorbent layers configured to:
receive an optical signal such that the optical signal passes through the layer, the optical signal having a specific polarization state and is associated with noise having a plurality of randomly varying polarization states; and
absorb optical waves having a particular polarization state, the particular polarization state being different from the polarization state associated with the other layers of the plurality of optically absorbent layers;
wherein the plurality of optically absorbent layers are coupled together such that as the optical signal and associated noise pass through the plurality of optically absorbent layers, the network element absorbs the associated noise more than the polarized optical signal to improve an Optical Signal to Noise Ratio (OSNR) of the optical signal.

9. The optical network of claim 8, wherein the plurality of optically absorbent layers comprises between fifty and one thousand layers.

10. The optical network of claim 8, wherein each layer of the plurality of optically absorbent layers comprises a plurality of quantum dots configured to absorb optical waves having the particular polarization state associated with the respective layer.

11. The optical network of claim 8, wherein each layer of the plurality of optically absorbent layers comprises a plasmonic nanocluster configured to absorb optical waves having the particular polarization state associated with the respective layer.

12. The optical network of claim 8, wherein each layer of the plurality of optically absorbent layers has a width less than one hundred nanometers.

13. The optical network of claim 8, further comprising an optical amplifier coupled to the noise reducer such that the noise reducer receives the optical signal from the optical amplifier to reduce Amplified Spontaneous Emission (ASE) noise associated with the optical amplifier.

14. The optical network of claim 8, wherein the optical signal is a 100 Gigabits/second (100 G) or greater optical signal.

15. A method for reducing noise associated with an optical signal comprising:
receiving, by a network element comprising a plurality of optically absorbent layers, an optical signal such that the optical signal passes through the plurality of optically absorbent layers, the optical signal having a specific polarization state and is associated with noise having a plurality of randomly varying polarization states; and
absorbing, by each layer of the plurality of optically absorbent layers, optical waves having a particular polarization state, the particular polarization state associated with each layer is different from the polarization state associated with the other layers of the plurality of optically absorbent layers such that as the optical signal and associated noise pass through the plurality of optically absorbent layers, the network element absorbs the associated noise more than the polarized optical signal to improve an Optical Signal to Noise Ratio (OSNR) of the optical signal.

16. The method of claim 15, wherein the plurality of optically absorbent layers comprises between fifty and one thousand layers.

17. The method of claim 15, wherein each layer of the plurality of optically absorbent layers comprises a plurality of quantum dots configured to absorb optical waves having the particular polarization state associated with the respective layer.

18. The method of claim 15, wherein each layer of the plurality of optically absorbent layers comprises a plasmonic nanocluster configured to absorb optical waves having the particular polarization state associated with the respective layer.

19. The method of claim 15, wherein each layer of the plurality of optically absorbent layers has a width less than one hundred nanometers.

20. The method of claim 15, further comprising receiving, by the network element, the optical signal from an optical amplifier to reduce Amplified Spontaneous Emission (ASE) noise associated with the optical amplifier.

21. The method of claim 15, wherein the optical signal is a 100 Gigabits/second (100 G) or greater optical signal.
